(19) United States
(12) Patent Application Publication
(10) Pub. No.: US 2025/0190706 A1
(43) Pub. Date: Jun. 12, 2025

(54) Information Systems that Detect, Diagnose, and Mitigate Cognitive Errors and Logical Fallacies

(71) Applicant: The Trustees of the Stevens Institute of Technology, Hoboken, NJ (US)

(72) Inventors: Jordan William Suchow, New York, NY (US); Vahid Ashrafimoghari, Jersey City, NJ (US)

(73) Assignee: The Trustees of the Stevens Institute of Technology, Hoboken, NJ (US)

(21) Appl. No.: 18/972,077

(22) Filed: Dec. 6, 2024

Related U.S. Application Data
(60) Provisional application No. 63/607,352, filed on Dec. 7, 2023.

(51) Int. Cl. G06F 40/30; G06F 40/284; G06F 40/295

(52) U.S. Cl. CPC G06F 40/30; G06F 40/284; G06F 40/295

(57) ABSTRACT

A system and methods are disclosed for detecting logical fallacies and other forms of spurious reasoning. Artificial Intelligence methods allow for direct processing of input data in the form of text, an image and/or video. The system can be trained and refined through machine learning algorithms. The invention can be standalone or integrated as part of a larger platform (e.g., as part of a social media platform). Feedback can be provided to allow a user to write more effectively, refine their thinking process, and/or construct sounder, more persuasive arguments. The model can be trained through databases and/or with the help of human annotations of training data.

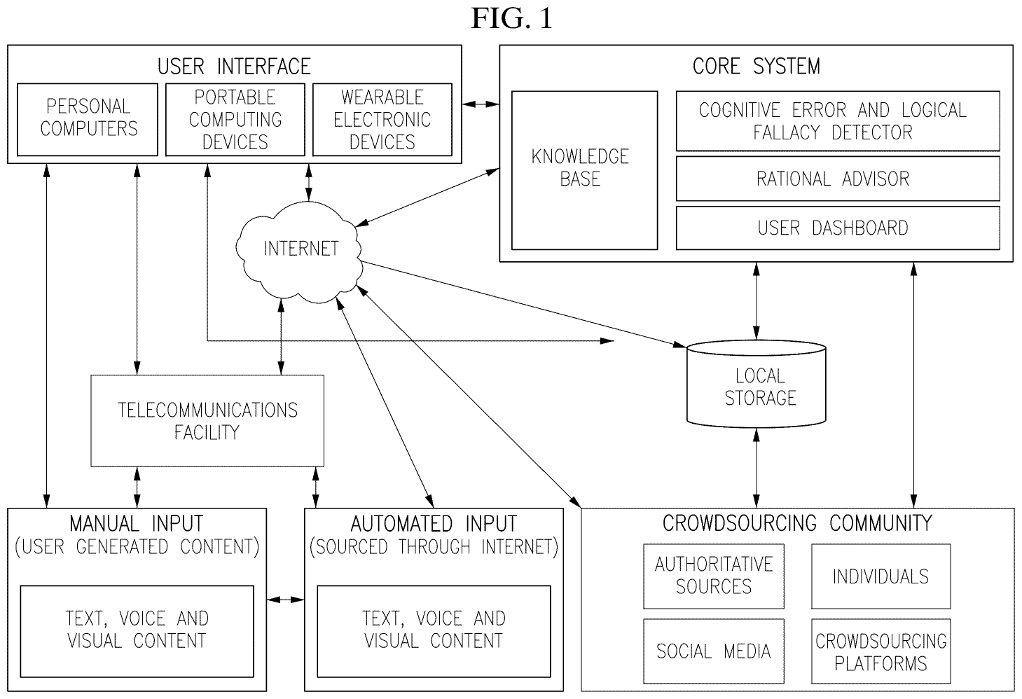

### CROSS REFERENCE TO RELATED APPLICATION

This application claims priority to U.S. Provisional Patent Application Ser. No. 63/607,352 filed Dec. 7, 2023, the entire disclosure of which is incorporated herein by reference.

### FIELD OF THE INVENTION

This application and the inventions disclosed herein relate to systems and their associated methods having the capability of detecting, diagnosing, and mitigating cognitive biases, logical fallacies, and the like.

### BACKGROUND OF THE INVENTION

Some related prior works could include, but are not limited to: Tools such as Grammarly and Microsoft Word's spell checker that identify and correct grammatical errors and typos in text; Snopes, FactCheck.org, and Google's Fact Check feature that identify false information and misinformation in text, Toulmin Model and Critic-Lite that aim to help users structure and analyze arguments in texts, and Open AI's GPT-3, GPT-3.5, and GPT-4, and Copy.ai that assist users with writing by providing suggestions and completing sentences based on input, are some of the tools that could be seen as related to an AI-powered system for checking cognitive errors and logical fallacies as they all aim to improve the quality arguments and reasoning of written and spoken materials.

### SUMMARY OF THE INVENTION

The present invention provides methods and systems for enabling a user to submit any content, regardless of its source, in the form of text, voice, or image from a computing device through an application programming interface (API). In return, the user receives a meticulously annotated version of the submitted content.

This enhanced output is specifically designed to identify and highlight any potential instances of cognitive biases or logical fallacies or the like that may be present within the content. The system further analyzes these errors and fallacies to predict their potential consequences and provide suggestions to mitigate their impact.

The process of detecting, annotating, diagnosing, and mitigating cognitive errors and logical fallacies is achieved through the application of machine learning, large language models, and other advanced artificial intelligence tools and algorithms that employ a comprehensive understanding of human cognition and logical reasoning. The algorithms are engineered to encompass a wide array of cognitive errors and logical fallacies, including, but not limited to, those detailed in Appendix A, located at the conclusion of this document.

### BRIEF DESCRIPTION OF THE DRAWING

For a more complete understanding of the present invention, reference is made to the attached drawing, which schematically depicts a flow diagram representative of one implementation of the present invention adapted for cognitive error detection usage.

### DETAILED DESCRIPTION OF THE INVENTION

The following disclosure is presented to provide an illustrative description of the general principles of the present invention and is not meant to limit, in any way, the inventive concepts contained herein. Moreover, the particular features described in this section can be used in combination with the other described features in each of the multitude of possible permutations and combinations contained herein.

All terms defined herein should be afforded their broadest possible interpretation, including any implied meanings as dictated by a reading of the specification as well as any words that a person having skill in the art and/or a dictionary, treatise, or similar authority would assign thereto.

Further, it should be noted that, as recited herein, the singular forms “a”, “an”, “the”, and “one” include the plural referents unless otherwise stated. Additionally, the terms “comprises” and “comprising” when used herein specify that certain features are present in that embodiment, however, this phrase should not be interpreted to preclude the presence or addition of additional steps, operations, features, components, and/or groups thereof.

All examples and conditional language recited herein are intended for pedagogical purposes to aid the reader in understanding the principles of the invention and the concepts contributed thereby to furthering the relevant art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

With reference to the attached drawing, an AI-powered system for checking cognitive errors and logical fallacies can be used for:
1. Improving academic writing and research papers: Scientific research often involves making arguments and presenting evidence to support claims. An AI-powered cognitive error and logical fallacy checking system can help researchers by providing real-time feedback as the text is being written and identifying instances of common logical fallacies, such as non-sequiturs, false equivalencies, and hasty generalizations. It can help authors become more aware of their reasoning and improve the rigor and validity of their arguments. Additionally, the system can also identify instances of cognitive biases that may affect the interpretation and presentation of data, such as confirmation bias and survivorship bias. By bringing these biases to light, the system can help authors avoid unintentionally distorting or misrepresenting their results.
2. Improving managerial decision-making: An AI-powered cognitive error and logical fallacy checking system can be used to evaluate reports and proposals, helping organizations to make better decisions by identifying potential biases, heuristics, irrational thought patterns, flawed reasoning in their thinking, and written communications. The system can analyze the text and identify instances where the decision maker may be succumbing to cognitive biases such as overconfidence, anchoring, or confirmation bias. By bringing attention to these cognitive errors, the system can help decision makers become more aware of their thinking and improve their decision-making processes by encouraging them to explore alternative perspectives and evaluate evidence objectively.
3. Enhancing critical thinking in education: The system can serve as a tool for students to develop their reasoning and argumentation skills. It can be integrated into classroom activities, writing assignments, and self-reflection exercises, where it can provide real-time feedback on the logic and coherence of students' arguments. By identifying common cognitive errors and logical fallacies, the system can help students become more aware of their thinking and learn to evaluate evidence and arguments objectively. Additionally, by highlighting these errors and fallacies, the system can encourage students to reflect on their thinking and consider alternative perspectives, helping to develop their critical thinking skills. This can lead to students who are better equipped to analyze and evaluate information, make informed decisions, and construct well-reasoned arguments in both academic and real-world contexts.
4. Evaluating public discourse: The system can be used to analyze political speeches, media articles, and other forms of public discourse. This can help journalists and citizens identify possible cognitive biases and flawed reasoning and improve the quality of public discourse. For example, the system could be used to analyze political campaigns to identify misleading claims and false associations.
5. Improving marketing communications: The system can improve marketing communications by assisting marketers in producing messages that are more effective and convincing. The system can analyze marketing messages, such as advertisements, product descriptions, and marketing materials, and identify instances of common cognitive biases, such as sunk cost fallacy, anchoring, and confirmation bias, that may affect the interpretation of information. By bringing these biases to light, the system can help marketers avoid unintentionally distorting or misrepresenting information. Additionally, the system can also identify instances of logical fallacies, such as false equivalencies, slippery slope arguments, and red herrings, that may detract from the overall quality and credibility of the message. By highlighting these fallacies, the system can encourage marketers to construct arguments that are more rigorous, valid, and convincing. Ultimately, this can lead to marketing communications that are more effective in capturing the attention of consumers and prompting them to act.
6. AI systems for argument generation: By analyzing the arguments generated by an AI system, the cognitive error and logical fallacy checking system can identify instances where the arguments may be flawed, such as when they are based on false premises, use non-sequiturs, or involve circular reasoning. This feedback can then be used to inform the AI argument generation system and improve its ability to generate valid and convincing arguments. Additionally, by detecting cognitive biases and logical fallacies, the system can also help to ensure that the arguments generated are free from bias and accurately reflect the relevant evidence and data. Ultimately, this can lead to AI argument generation systems that produce arguments that are more persuasive, rigorous, and trustworthy, which can be useful in a variety of applications, such as legal and policy debates, product recommendations, and persuasive advertising.
7. Improving online discourse: The system can be used to improve online discourse by promoting critical thinking and reducing the spread of misinformation. The system can be integrated into online platforms, such as social media, forums, and news websites, where it can analyze user-generated content in real-time and provide feedback on the logic and coherence of arguments. By identifying instances of cognitive biases, such as confirmation bias, sunk cost fallacy, and framing effects, the system can help users to become more aware of how these biases may influence their thinking and the arguments they make. Additionally, by highlighting instances of logical fallacies, such as straw man arguments, false equivalencies, and hasty generalizations, the system can encourage users to construct arguments that are more valid and convincing.
8. Improving legal argumentation: The legal profession often involves making arguments and counterarguments in a court of law. An AI-powered cognitive error and logical fallacy checking system could be used to improve legal argumentation by providing real-time feedback to legal professionals and helping to ensure that their arguments are based on sound reasoning and evidence. The system can analyze legal briefs, motions, and other legal documents and identify instances of cognitive biases, such as confirmation bias, sunk cost fallacy, and framing effects, that may influence the interpretation of information. By highlighting potential cognitive biases, the system can help legal professionals to avoid unintentional errors in their reasoning and present arguments that are more accurate and objective. Additionally, the system can also identify instances of logical fallacies, such as false equivalencies, slippery slope arguments, and red herrings, that may detract from the quality and credibility of their arguments. By highlighting these fallacies, the system can encourage legal professionals to construct arguments that are more rigorous, valid, and convincing. This can lead to legal arguments that are better grounded in evidence and more effective in convincing judges and juries, which can ultimately lead to better outcomes for clients.
9. Improving public health communication: The system can enhance public health communication by promoting evidence-based, trustworthy messages. It can be integrated into various public health messaging platforms, including campaigns, educational materials, and news articles. By identifying biases and fallacies in messages, the system can help to ensure that information is more accurate and based on sound reasoning. The result is public health communication that is more effective in educating the public and promoting healthy behaviors, leading to improved health outcomes.
10. Assisting in political fact-checking: The system can play a role in political fact-checking by quickly and accurately identifying instances of misinformation in political discourse. The system can be integrated into news outlets, social media platforms, and other sources of political information and analyze political statements, speeches, and other forms of political communication. By detecting cognitive biases and logical fallacies in political messages, the system can help to flag instances of misinformation and provide alternative, fact-based perspectives. This can assist journalists and other fact-checkers in their efforts to hold political actors accountable and promote accuracy in political discourse, ultimately leading to a better-informed public. The system could also provide valuable insights into patterns of misinformation, enabling stakeholders to take proactive measures to address them.
11. Improving argumentation in business negotiations: In business negotiations, it is important to make clear and compelling arguments. An AI system for checking cognitive errors and logical fallacies can enhance business negotiations by facilitating clear and effective communication. It can help to reduce misunderstandings and increase the chances of reaching a mutually beneficial agreement. The system can assist negotiators in making decisions that are based on objective and fact-based reasoning, rather than being influenced by emotional or irrational factors. This can help to reduce the risk of impulsive decisions and increase the chances of reaching a win-win agreement. Also, the system can provide a neutral third-party perspective on arguments, which can encourage negotiators to engage in constructive criticism and improve their reasoning skills. This can lead to more productive negotiations and better outcomes. Finally, by providing negotiators with objective feedback on their arguments, the system can promote transparency and accountability in negotiations. This can increase trust between parties and make negotiations more efficient and effective.
12. Enhancing customer support: The system can improve the quality and efficiency of customer support, leading to higher levels of customer satisfaction and engagement. The system can analyze the responses provided by customer support representatives to ensure that they are free of cognitive biases and logical fallacies, resulting in more accurate and effective responses. By automating the process of identifying and correcting cognitive errors, the system can help customer support representatives to respond to customers more quickly and efficiently. Also, by providing customers with clear, accurate, and well-reasoned responses to their questions, the system can help to increase customer satisfaction and loyalty. Ultimately, the system can identify potential cognitive errors in customers' requests or complaints, helping the customer service representatives to provide customized responses that are tailored to customer's specific needs and requirements.

Many potential future use cases for an AI-powered cognitive error and logical fallacy checking system are yet to be realized. As AI and machine learning technologies continue to advance, new applications for such a system will likely emerge. Some potential future uses for this technology include:
Assisting in Therapy: In the future, cognitive bias checking systems may help identify and correct biases in mental health assessments and treatment. The system could analyze patient data and identify and correct cognitive errors in diagnosis and treatment decisions.
Improving policymaking: This system could be used to evaluate policy proposals, identifying and correcting flawed reasoning in policy arguments. This could help to improve the quality and accuracy of policymaking and promote more informed policy decisions. In the future, these systems may help identify and correct biases in government policy. The AI system could analyze policy proposals, regulations, and laws to detect and correct policy design and implementation biases.
Public Safety: In the future, AI-powered cognitive error and logical fallacy checking systems may help identify and correct public safety and emergency response biases. The AI system could analyze incident data and detect and correct for biases in response times, allocation of resources, and incident resolution.
Environmental Management: In the future, AI-powered cognitive error and logical fallacy checking systems may help identify and correct biases in environmental management. The AI system could analyze environmental data and detect and correct resource allocation, land use, and environmental protection biases.
Artificial Intelligence Development: In the future, AI-powered cognitive error and logical fallacy checking systems may help identify and correct biases in developing and deploying artificial intelligence systems. The AI system could analyze AI models and data to detect and correct biases in algorithmic design, data collection, and analysis.
Predictive fallacy detection: In the future, an AI-powered cognitive error and logical fallacy checking system may be able to predict the likelihood of a fallacy occurring in a text, even before the text has been written. This could be useful in a variety of contexts, including political speechwriting, legal argumentation, and scientific research.
Automated reasoning: As AI technology continues to advance, it may be possible to develop systems that can automatically generate arguments and explanations and use a fallacy detection system to evaluate their quality. This could lead to the creation of AI-powered reasoning tools that can be used in a variety of fields. In the future, an AI-powered cognitive error and logical fallacy checking system may be integrated into automated decision-making systems, helping to improve the quality and accuracy of decision-making. This could be useful in fields such as finance, healthcare, and criminal justice, where automated decision-making is becoming increasingly common.
Personalized critical thinking: In the future, an AI-powered cognitive error and logical fallacy checking system may be able to personalize its feedback to individual users based on their writing style, knowledge base, and critical thinking skills. This could help users to develop their critical thinking skills more effectively and efficiently.
Enhanced natural language processing: As natural language processing technology improves, an AI-powered cognitive error and logical fallacy checking system may be able to understand and analyze the meaning of the text more accurately, improving its ability to identify cognitive errors and logical fallacies.
Improving journalism: The system could be used to improve the quality of journalism by identifying and correcting flawed reasoning in news articles, opinion pieces, and other forms of journalism. This could help to reduce the spread of misinformation and improve the credibility of journalism.
Improving advertising: The system could be used to evaluate the quality of advertising, identifying and correcting flawed reasoning in advertisements. This could help to improve the accuracy and credibility of advertising and reduce the spread of false or misleading advertising claims.

A general outline of how an AI-powered cognitive error and logical fallacy checking system can be used to obtain the desired utility could be as follows:
1. Data collection: Collect and label a large dataset of texts related to all domains where the system could be used (e.g., customer support, business negotiations, academic writing, etc.). This dataset will be used to train the AI system.
2. Model training: Train a machine learning model on the collected dataset to identify and categorize cognitive biases and logical fallacies in texts.
3. Integration with existing systems: Integrate the system with existing customer support, business negotiation, or academic writing platforms.
4. Text analysis: Analyze the texts written by users (e.g., customer support representatives, negotiators, researchers, etc.) to identify potential cognitive biases and logical fallacies.
5. Feedback and suggestions: Provide feedback and suggestions to the users on how to improve their texts and reduce the presence of cognitive biases and logical fallacies.
6. Monitoring and improvement: Continuously monitor the system's performance and improve it based on feedback and user behavior.

This outline can be modified and adapted to fit the specific needs and requirements of different domains and use cases. However, the overall process remains the same.

An AI-powered system for checking cognitive errors and logical fallacies can solve several problems and has several advantages, including:
Reducing bias and logical fallacies: By identifying and correcting potential cognitive biases and logical fallacies in texts, the system can help to reduce the presence of cognitive errors in decision-making, communication, and research.
Improving accuracy: By detecting and correcting logical fallacies and cognitive biases in texts, the system can improve the accuracy and credibility of the information being presented.
Enhancing critical thinking: By providing feedback and suggestions on how to improve texts and reduce the presence of cognitive biases and logical fallacies, the system can enhance critical thinking skills and encourage the development of more rigorous and well-reasoned arguments.
Saving time and resources: By automating the process of identifying and correcting cognitive biases and logical fallacies, the system can save time and resources that would otherwise be required to manually review and edit texts.
Promoting consistency: By providing standardized guidelines and feedback to all users, the system can promote consistency and help to ensure that all texts are free of cognitive biases and logical fallacies, regardless of the individual writing styles.
Supporting personalization: By analyzing the individual needs and preferences of users, the system can provide tailored feedback and suggestions that are specific to their unique needs and requirements.
Improving communication: By reducing the presence of cognitive biases and logical fallacies in texts, the system can improve communication and help to foster more productive and effective exchanges between individuals and organizations. Decreasing subjectivity: The system's objective analysis of texts can help to minimize subjectivity and ensure that information is presented in a neutral and impartial manner.
Encouraging research transparency: By identifying and correcting logical fallacies in research papers, the system can promote research transparency and help to ensure that research findings are credible and trustworthy.
Improving collaboration: By providing clear and concise feedback on texts, the system can facilitate more efficient and effective collaboration between individuals and organizations, as well as improve the overall quality of the final product.
Facilitating knowledge transfer: By helping to identify and correct errors and biases in texts, the system can help to ensure that knowledge is transferred effectively and accurately and can support the development of best practices in various domains.
Supporting personal development: By providing feedback and suggestions to individuals on how to improve their arguments and writing, the system can support personal development and help individuals to expand their skills and knowledge.
Encouraging ethical considerations: By highlighting the potential ethical implications of texts, the system can encourage individuals and organizations to consider ethical issues and take steps to address them.

The core components of the AI-powered system for checking cognitive errors and logical fallacies, are:
Knowledge Base (KB): This component contains information on various types of cognitive biases, cognitive distortions, and logical fallacies, including their definitions, examples, and patterns. Also, information on all aspects of the logical reasoning and rational thinking, including its definitions, examples, and patterns are maintained in the knowledge base. Moreover, a database of world facts including statistics and evidence-based findings, which is collected from external sources, is included. The information within the knowledge base is sourced and regularly updated through contributions from the crowdsourcing community and the internet. A real-time version of the knowledge base is accessible on the cloud server, and a backup version is routinely stored on the local server.
Cognitive Error and Logical Fallacy Detector (CELFD) which is responsible for processing and analyzing the input and identifying potential cognitive errors and logical fallacies within it. In the first step, it performs NLP tasks such as tokenization, named entity recognition, and sentiment analysis on the input after converting it to text, preparing it for the next step. In the second step, information from the knowledge base is applied to the content, evaluating the arguments and reasoning presented, and determining if there are any cognitive errors or logical fallacies present in the processed input. This component employs pre-trained and fine-tuned custom AI models to detect and highlight potential cognitive errors and logical fallacies in an input given.
Rational Advisor (RA) which is responsible for diagnosing and generating suggestions to mitigate potential cognitive errors and logical fallacies. Indeed, it is an advanced recommender system that employs artificial intelligence models and prescriptive analytics to furnish comprehensive insights regarding any cognitive errors or logical fallacies identified by the CELFD. It not only highlights the possible consequences of these cognitive errors and logical missteps but also offers strategic recommendations for addressing, managing, and mitigating them effectively. By doing so, the system enhances users' decision-making processes, ensuring a more rational and bias-aware approach to decision making and analysis.
User Dashboard (UD): This integral component is tasked with the presentation and generation of detailed reports based on the outcomes of the cognitive error and logical fallacy detection, as well as the subsequent recommendations provided by the rational advisor. These reports serve as valuable tools for individual users to monitor their cognitive development and for organizations to assess the quality of their reasoning, judgments, decisions, and overall communication strategies. To cater to diverse user preferences and learning styles, the feedback mechanism within this component can be designed in multiple formats. Options include text-based feedback, which offers a clear and concise written summary of findings; visual representations, which map out the structure of arguments for easy comprehension; and even audio feedback, providing an auditory review of the analysis. This multifaceted approach ensures that users and organizations can engage with and benefit from the insights in a manner that best suits their needs.
User Interface (UI): This essential component offers users a gateway to engage with the system, allowing them to submit content in textual, vocal, and visual formats for thorough evaluation. It also facilitates the delivery of feedback regarding the quality of their arguments and reasoning. The design of the user interface can be tailored to meet a spectrum of user needs and preferences, spanning from a straightforward text-based interface, which provides a minimalist and focused environment for input and feedback, to a more complex graphical user interface (GUI). The GUI option incorporates visual elements and interactive components that enhance user experience, making the process of navigating the system, submitting content, and understanding feedback more intuitive and user-friendly. By offering a range of interface designs, the system ensures accessibility and ease of use for all users, regardless of their technical proficiency or cognitive style.
Data Storage Component (DS): This component serves as the repository for all data entered into the system, as well as the feedback generated by the system. It is designed to securely store not only the content submitted for analysis but also a comprehensive record of user interactions with the system. This includes detailed information on the users themselves, such as their individual preferences, historical usage patterns, and any custom settings they may have configured. By maintaining this data, the system can offer a more personalized and efficient user experience over time. To ensure robustness and reliability, the data storage component utilizes both cloud servers and local servers. The cloud servers provide scalable and accessible storage solutions, allowing for seamless data management and backup, while the local servers offer additional redundancy and can facilitate faster access within the organization's internal network. This dual-server approach guarantees that data is not only well-protected but also readily available for analysis, reporting, and system improvement purposes.

Also, it would be possible to integrate the system for checking cognitive errors and logical fallacies with other tools and systems, such as word processors, content management systems, and communication platforms. This component allows users to leverage the power of the system within the context of their existing workflows and processes.

Like any other technology, an AI-powered system for checking cognitive errors and logical fallacies has its own disadvantages and limitations compared to competing technologies:
Accuracy: AI models are not perfect, and they can make mistakes. There may be false positives or false negatives in the fallacy and bias detection results.
Data bias: The accuracy of the system may be affected by the data it was trained on. If the training data is biased in some way, the system may also be biased.
Context sensitivity: Logical fallacies and cognitive errors can be difficult to detect in context, as the meaning of words and phrases can change based on the context in which they are used. The system may have difficulty detecting fallacies and biases in complex or abstract texts.
Limitations of NLP and machine learning: Natural Language Processing (NLP) and machine learning algorithms are still developing, and there may be limitations in their ability to accurately process and analyze texts.
Cost: Developing and deploying an AI-powered system for checking logical fallacies and cognitive errors can be expensive, especially if a machine learning model needs to be trained from scratch.
Maintenance: The system requires regular maintenance to stay up to date with the latest advancements in NLP and machine learning and to ensure that the fallacies and biases being detected are still relevant.
Limitations of feedback: The feedback generated by the system may be limited and may not cover all the possible ways to improve reasoning and writing. It may also not be able to consider the specific goals and style of the writer.

To overcome disadvantages and limitations of the system, it is possible to develop more advanced AI models and using more diverse and comprehensive training data can help improve the accuracy of the system. Using diverse and balanced training data, and implementing algorithmic fairness techniques, can help mitigate the impact of data bias on the accuracy of the system. Developing advanced NLP algorithms and using contextual information, such as word embeddings, can help the system better understand the context in which words and phrases are used, and make more accurate fallacy and bias detections. As NLP and machine learning technologies advance, the limitations of the system may be overcome, making it more accurate and capable of handling complex and abstract texts. Developing open-source or low-cost solutions, or using cloud-based platforms, can help lower the cost of developing and deploying an AI-powered system for checking logical fallacies and cognitive biases. Regularly updating the system with the latest advancements in NLP and machine learning and using the feedback from users can help keep the system up-to-date and relevant. Ultimately, incorporating more human feedback and allowing users to customize the feedback generated by the system can help make it more relevant and useful for writers. Additionally, providing more detailed and specific feedback can help writers better understand the logic behind their writing and improve their reasoning and writing skills.

The AI-powered cognitive error and logical fallacy checking system has some novel and unique features that make it a valuable tool for addressing biases and logical fallacies in various domains. Some of its features include:
Automated Bias Detection: One of the unique features of the system is its ability to automate the process of bias detection. Traditional bias detection methods often rely on human experts, which can be time-consuming and prone to error. With this system, bias detection can be automated, allowing faster and more accurate results.
Continuous Monitoring: Another unique feature of the system is its ability to monitor data continuously and detect changes in bias over time. This allows organizations to keep track of biases as they evolve, making it possible to respond quickly and effectively to changing biases.
Scalability: The system can be scaled to handle large volumes of data, making it possible to analyze data from large organizations or complex systems. This allows organizations to understand biases comprehensively and make informed decisions about how to correct them.
Customizability: The system can be customized to suit the needs of specific organizations or applications. This allows organizations to tailor the system to meet their particular requirements and focus on the most relevant biases to their operations.
Objectivity: The system can provide an objective and unbiased assessment of biases in data. This is because the system is not influenced by personal opinions, biases, or experiences, making it a valuable tool for promoting fairness and objectivity in decision-making processes.
Real-time Checking: The system can implement real-time checks on the data they are analyzing. This allows organizations to address biases as they occur, reducing the impact of these biases on decision-making processes.
Integration with other AI systems: The system can be integrated with other AI systems, such as natural language processing (NLP) systems, computer vision systems, or AI-powered writing assistants to provide a comprehensive and integrated solution for addressing biases.
Machine Learning-Based Checking: The system uses machine learning algorithms to correct for biases in data. This allows the system to learn from previous checks and make increasingly accurate checking over time.
Personalization: The system allows for personalization, allowing users to customize the system to their specific needs and preferences. This can include adjusting the system's sensitivity to different biases or allowing users to set their bias checking thresholds.
Data Privacy: The system can be designed with data privacy in mind, allowing organizations to protect sensitive data while still taking advantage of the benefits of bias checking.
Multilingual capabilities: The system could be customized to analyze texts in multiple languages, making it a valuable tool for users who are looking to improve their critical thinking skills in multiple languages.
Integration with learning management systems: The system could be integrated with learning management systems, allowing educators to assign critical thinking exercises and receive feedback on the quality of reasoning of their students.
Customizable fallacy library: The system could be designed with a customizable fallacy library, allowing users to add their own fallacies or remove fallacies that are not relevant to their specific needs.
Ability to provide counterarguments: The system could be designed to provide counterarguments to identified logical fallacies, helping users to understand why a particular fallacy is flawed and how they might improve their reasoning.

These are just a few unique and novel features of an AI-powered cognitive error and logical fallacy checking system. By automating the process of bias detection, providing continuous monitoring, and offering scalability, customizability, and objectivity, this technology provides a powerful tool for addressing biases and promoting fairness in a wide range of applications.

A prototype of a system that identifies explicit mentions of cognitive biases in texts has been developed and tested experimentally by using one or a combination of the following methods:
Accuracy testing: One of the most important metrics for evaluating the performance of the system is accuracy. It can be tested by comparing its outputs with human annotations or ground truth data. For example, the system can be fed a set of texts, and the outputs of the system can be compared with the annotations made by human annotators. The accuracy of the system can be calculated as the ratio of correct detections of fallacies and biases to the total number of detections made by the system.
Cross-validation: Cross-validation is a technique used to evaluate the performance of the system on previously unseen data. In this technique, a part of the training data is used as a test set, and the remainder is used to train the model. For example, if the training data consists of 100 texts, 80 texts can be used to train the model, and the remaining 20 texts can be used as the test set. The system can then be evaluated by comparing its outputs on the test set with the human annotations or ground truth data.
User studies: User studies can help to evaluate the effectiveness of the system in practice. It can be conducted by having users write texts and using the system to detect logical fallacies and cognitive biases. The users can then rate the relevance and usefulness of the feedback provided by the system. For example, a group of users can write texts on a given topic, and the system can provide feedback on the presence of logical fallacies and cognitive biases in the texts. The users can then rate the feedback provided by the system on a scale of 1 to 5, with 5 being the highest.
Ablation studies: Ablation studies are used to evaluate the contribution of each component of the system to its overall performance. It can be managed by removing one or more components of the system and evaluating its performance without them. For example, ablation studies can be performed by removing any of sub-components of the CELFD or the RA and evaluating the performance of the system without it. This will help to understand the importance of each component or sub-component to the overall performance of the system.
Robustness testing: Robustness testing is used to evaluate the stability of the system in the presence of inputs with varying lengths, styles, and levels of complexity. For example, the system can be fed texts with different lengths, ranging from short sentences to long paragraphs. The system's performance can then be evaluated by comparing its outputs with the human annotations or ground truth data.
Performance testing: Performance testing is used to evaluate the scalability and efficiency of the system. It can be conducted by testing the system's performance on large datasets, or by comparing its performance with that of competing technologies. For example, the system can be tested on a dataset of 100,000 texts, and the time taken by the system to process the dataset can be measured. The performance of the system can then be compared with that of other systems that perform similar tasks.
Inter-annotator agreement: Inter-annotator agreement is used to evaluate the consistency of the system's outputs with human annotations. It can be performed by having multiple annotators annotate the same content and comparing their annotations with those of the system. For example, if three annotators annotate a set of 10 texts, the agreement between their annotations can be calculated, and the agreement between the annotations of the annotators and the system can also be calculated. The agreement between the annotations of the annotators and the system can then be compared to evaluate the consistency of the system's outputs.

Cross-validation testing has been performed on a dataset of 12K text excerpts which are labeled by a human annotator for 341 cognitive biases and logical fallacies. The dataset then has been split to 85%-15% between training and testing. The results illustrated that the tool already classifies cognitive biases in texts with 93% accuracy.

Such a prototype system can be constructed through the following steps:
1. Data Collection: The first step would be to collect a large corpus of text data that includes a variety of logical fallacies and cognitive biases. This data will be used to train the machine learning model.
2. Data Preprocessing: The collected data needs to be preprocessed to remove any irrelevant information and to format it in a way that can be easily used by the machine learning algorithms. This could involve tokenizing the text, converting the text into numerical representations, and splitting the data into training, validation, and testing sets.
3. Model Development: Next, a machine learning model needs to be developed that can identify logical fallacies and cognitive biases in text. This could be done using deep learning techniques such as Convolutional Neural Networks (CNNs) or Recurrent Neural Networks (RNNs).
4. Model Training: The model developed in the previous step is then trained on the preprocessed data to learn the relationships between text and logical fallacies/cognitive biases. This involves adjusting the model's parameters so that it can make accurate predictions on the training data.
5. Model Evaluation: The model's performance is evaluated using the validation data set to see how well it generalizes to new text data. The model's hyperparameters may need to be adjusted based on the evaluation results.
6. User Interface: Finally, a user interface needs to be developed that allows users to input text and receive recommendations for mitigating logical fallacies and cognitive biases. The interface should also allow users to view the system's predictions and the reasoning behind them.
7. Deployment: The prototype system can then be deployed and made available for use by users.

The AI-powered system for checking cognitive errors and logical fallacies can be used in a number of commercial products and processes, including:
Writing software: The system could be integrated into writing software such as word processors or text editors. This would allow users to identify logical fallacies in their writing in real-time and make edits as necessary.
News and media websites: The system could be used to check the content posted on news and media websites, ensuring that articles are free of logical fallacies and biases.
Educational software: The system could be integrated into educational software and used as a tool to teach critical thinking skills and to help students identify logical fallacies in texts they encounter in their studies.
Online Tutoring Systems: The system can be integrated into online tutoring systems to identify and correct biases in student evaluations, feedback, and assessment results.
Social media platforms: The system could be used to monitor and detect logical fallacies in posts and comments on social media platforms, helping to reduce the spread of misinformation and false information.
Healthcare Systems: The system can be integrated into healthcare systems to identify and correct biases in medical diagnosis and treatment recommendations.
Business and marketing: The system could be used by businesses and marketing teams to check the persuasiveness of their communications and to ensure that they are free of logical fallacies and biases.
E-discovery software: The system could be used in e-discovery software to quickly and accurately identify logical fallacies in large volumes of text data.
Legal research tools: The system could be integrated into legal research tools, helping lawyers and legal researchers identify logical fallacies in legal texts and case law.
Political analysis software: The system could be used in political analysis software to identify logical fallacies in political speeches, debates, and campaign materials.
Speech recognition software: The system could be integrated into speech recognition software, allowing users to identify logical fallacies in real-time as they listen to speeches and presentations.
Customer service chatbots: The system could be integrated into customer service chatbots, allowing the chatbots to identify and mitigate logical fallacies in customer interactions, improving the overall customer experience.

The AI-powered system for checking logical fallacies in texts could be of interest to many industries, including, but limited to:
Education: Schools and universities could use the system as a tool for teaching critical thinking and logic to students.
Legal: The legal industry could use the system to quickly and accurately identify logical fallacies in legal texts, improving the efficiency of legal research and analysis.
Political analysis: Political organizations, think tanks, and news outlets could use the system to identify logical fallacies in political speeches and debates, providing a more accurate and nuanced analysis of political events.
Technology: Software development companies and tech startups could integrate the system into their existing products, improving the quality and accuracy of their offerings.
Healthcare: Healthcare organizations and research institutions could use the system to identify logical fallacies in scientific papers and medical texts, improving the accuracy of medical research and patient care.
Marketing and advertising: Advertisers and marketing agencies could use the system to evaluate the persuasiveness of advertisements and marketing campaigns, improving their marketing strategies.
Public relations: Public relations firms and government organizations could use the system to identify logical fallacies in press releases and official statements, improving their messaging and credibility.
Media: News outlets, television and radio stations, and publishers could use the system to identify logical fallacies in reporting and programming, providing more accurate and trustworthy information to their audiences.
Finance: Investment firms and financial institutions could use the system to evaluate financial reports and market analysis, improving their decision-making processes.
Sociology and psychology: Researchers and institutions in the fields of sociology and psychology could use the system to identify logical fallacies in academic papers and survey data, improving the accuracy of their research findings.

Also, there are several government agencies that might be interested in the AI-powered system for checking logical fallacies in texts:
Ministry of Education: The Ministry of Education could use the system to identify logical fallacies in student essays and written assignments, improving the quality of education and critical thinking skills.
Department of Justice: The Department of Justice could use the system to identify logical fallacies in legal briefs and court documents, improving the accuracy and fairness of legal proceedings.
Intelligence Agencies: Intelligence agencies could use the system to identify logical fallacies in intelligence reports and assessments, improving the accuracy of their decision-making processes.
Legislative Bodies: Legislative bodies such as parliaments and congresses could use the system to identify logical fallacies in legislation and policy proposals, improving the quality of legislation and policy decisions.
Regulatory Agencies: Regulatory agencies such as the Securities and Exchange Commission (SEC) and the Federal Communications Commission (FCC) could use the system to identify logical fallacies in company reports and regulatory filings, improving their regulatory decision-making processes.
Ministry of Foreign Affairs: The Ministry of Foreign Affairs could use the system to identify logical fallacies in diplomatic communiques and international agreements, improving the accuracy and fairness of international negotiations and agreements.
Department of Defense: The Department of Defense could use the system to identify logical fallacies in military intelligence reports and assessments, improving the accuracy of their decision-making processes in matters of national security.
Electoral Commissions: Electoral commissions could use the system to identify logical fallacies in political speeches, advertisements, and debates, improving the accuracy and fairness of political campaigns and elections.
Government Information Services: Government information services such as press offices and public relations departments could use the system to identify logical fallacies in official statements, improving the accuracy and fairness of government communications with the public.
Research Agencies: Research agencies such as the National Science Foundation (NSF) and the National Institutes of Health (NIH) could use the system to identify logical fallacies in grant proposals and research papers, improving the accuracy and fairness of funding decisions and scientific research.

An AI-powered system for checking cognitive errors and logical fallacies differs from present technology in several ways:
Increased speed and accuracy: Compared to manual methods of checking for cognitive errors and logical fallacies, this system can analyze a given piece of content much faster and more accurately. This means that users can receive feedback on the quality of their reasoning more quickly and with greater accuracy.
Real-time feedback: Unlike traditional methods of checking for cognitive errors and logical fallacies, which often involve submitting a text for review by a human expert, this system provides real-time feedback, allowing users to make corrections to their reasoning in real-time.
Customizability: The system can be designed to provide personalized feedback to users, with regards to factors such as their writing style, knowledge base, and critical thinking skills. This allows users to receive feedback that is tailored to their specific needs, making it more effective and efficient.
Continuous improvement: As the system is exposed to more and more texts, it can continually improve its ability to identify logical fallacies. This means that its accuracy and effectiveness will increase over time, making it a valuable tool for users who are looking to improve their critical thinking skills.
Integration with other AI technologies: An AI-powered system for checking cognitive errors and logical fallacies can be integrated with other AI technologies, such as natural language processing, machine learning, and computer vision. This allows for the development of even more advanced and sophisticated systems that can analyze and evaluate text in new and innovative ways. Other possible differences include:
Machine Learning-based: Unlike other prior art that may rely on rule-based systems or expert knowledge to identify logical fallacies, this system uses machine learning algorithms to identify and recommend ways to mitigate logical fallacies in text. This allows for a more flexible and adaptive approach that can handle a wider range of fallacies and biases.
Personalized Recommendations: This system could provide personalized recommendations for mitigating logical fallacies and cognitive biases based on the text input by the user. This could help users better understand and address the specific fallacies and biases present in their text.
Reasoning Behind Recommendations: This system could provide a reasoning behind its recommendations for mitigating logical fallacies and cognitive biases, allowing users to better understand the rationale behind the recommendations.
Integration with Other Tools: This system could be integrated with other tools such as text editors, content management systems, or educational platforms, to provide real-time feedback to users as they write.

Many firms such as consulting firms, educational institutions, marketing and advertising agencies, legal firms, public health organizations, political organizations, government agencies could be potential users of this system. Also, tech companies that specialize in AI and language processing, such as OpenAI, IBM Watson, Google AI, and Microsoft Research, could potentially be interested in integrating such a system into their own products and services.

### EXAMPLE 1

### Fallacies Encompassed Within the Scope of the Present Invention

Attentional bias: The tendency for one's perception to be influenced by persistent thoughts.

Illusory truth effect: The tendency to accept a statement as true when it is simpler to comprehend or has been repeatedly asserted, irrespective of its factual accuracy. These instances exemplify the concept of truthiness.

Mere exposure effect: The tendency to exhibit an irrational preference for entities simply due to their familiarity.

Context effect: The phenomenon where cognition and memory are contextually bound, rendering memories that are out of context harder to recall than those in context. For instance, the ability to recall a work-related memory is likely to be less accurate and take more time when one is at home, and similarly, home-related memories are harder to retrieve in the workplace.

Retrieval-induced forgetting/Cue-dependent forgetting: Cue-dependent forgetting, also known as retrieval failure, refers to the inability to recall information in the absence of specific memory cues. This concept encompasses various types of cues, including semantic, state-dependent, and context-dependent cues. Certain memories are not retrievable through direct effort; instead, they require the activation of associated elements to trigger recollection.

Mood-congruent memory bias: The enhanced ability to remember information that aligns with one's current emotional state.

Frequency illusion/Baader-Meinhof phenomenon/Frequency bias: The phenomenon where, upon observing something for the first time, an individual is more likely to notice it repeatedly, which can create the false impression that its occurrence has become more frequent.

Empathy gap and actions: The tendency to underestimate the impact that intense emotional impulses have on one's attitudes, choices, a.

Omission bias: The omission bias is the tendency to perceive harmful actions as more reprehensible than equally harmful inactions, regardless of the similarity in outcomes.

Base rate fallacy: The propensity to overlook broadly applicable information in favor of details specific to a particular instance, even when the general information is of greater relevance.

Bizarreness effect: Unusual or odd content is more likely to be retained in memory than commonplace material.

Humor effect: Items that are humorous tend to be more readily recalled than those that are not, potentially due to the unique nature of humor, the extended cognitive effort required to comprehend the humor, or the emotional stimulation elicited by the humorous content.

Von Restorff Effect: The Von Restorff effect, or the Isolation Effect, posits that within a group of similar entities, the one that stands out due to its distinctiveness is more likely to be remembered.

Picture superiority effect: The idea that concepts absorbed through visual imagery are more readily and frequently remembered than those learned through reading their textual representations.

Self-relevance effect: The self-reference effect (SRE) describes the phenomenon where information pertinent to oneself is remembered more effectively than information that relates to others. Typically, the SRE is observed under circumstances where associations between the stimuli and the self are established during the encoding phase of memory formation.

Negativity bias: The psychological phenomenon where humans exhibit a stronger ability to recall memories that are unpleasant as opposed to those that are positive.

Illusion of transparency: The propensity for individuals to overvalue the extent to which their own mental state is perceived by others, as well as to overrate their comprehension of the mental states of other people.

Curse of knowledge: It referrers to the cognitive challenge experienced by well-informed individuals when attempting to view issues from the perspective of those with less information.

Spotlight effect: The tendency to exaggerate the extent to which others observe and scrutinize one's physical appearance or conduct.

Correspondence bias: The tendency to attribute an individual's actions to their stable character traits rather than to the specific circumstances that may have prompted those behaviors.

Illusion of explanatory depth: The tendency to overestimate one's understanding of a topic is more pronounced for explanatory knowledge. People generally have a more accurate self-assessment of their skills in procedural, narrative, or factual knowledge domains.

Illusion of knowing/understanding/comprehension: The illusion of knowing refers to the mistaken belief that one has adequately comprehended and learned something, despite actually lacking a true understanding.

Reciprocity bias or Reciprocity effect: The tendency to respond in kind to the actions others have directed toward us.

Self-consistency bias: The widespread belief in one's own consistency regarding attitudes, opinions, and beliefs, which is often greater than the actual consistency. This includes the inability to recognize changes in one's own thoughts or opinions due to the conviction that one has always thought the same way.

Restraint bias: The tendency to overestimate one's capacity to resist temptation and exercise self-control.

Projection bias: The tendency to overestimate the degree to which our future selves will align with our current preferences, thoughts, and values, can result in choices that are not optimal.

Pro-innovation bias: The tendency to exhibit disproportionate optimism about the utility of an invention or innovation across society, while frequently overlooking its potential limitations and drawbacks.

Time saving bias: A tendency to misjudge the time savings (or losses) when changing speeds, specifically underestimating the time saved (or lost) when accelerating (or decelerating) from a lower speed, and overestimating the time saved (or lost) when changing speeds from a higher speed.

Planning fallacy: The tendency for individuals to misjudge the duration required to finish a specific task, often predicting a shorter time frame than what is realistically needed.

Pessimism bias: The tendency among certain individuals, particularly those suffering from depression, to overestimate the probability of adverse events occurring in their lives.

Impact/Intensity bias: The tendency to overestimate the duration or intensity of future emotional responses.

Declinism or Rosy Retrospection: The tendency to remember the past more positively (rosy retrospection) while anticipating the future with a negative outlook.

Moral luck: The tendency to attribute a higher or lower moral status to individuals based on the outcomes of events.

Outcome bias: The tendency to evaluate a decision based on its ultimate outcome rather than assessing the decision's merit at the time it was made.

Hindsight bias: Often referred to as the “I-knew-it-all-along” effect, this is the tendency to perceive past events as having been predictable at the time they occurred.

Telescoping effect: The tendency to erroneously perceive recent events as if they occurred further in the past and distant events as if they happened more recently, thus distorting the perceived temporal distance of events.

Risk compensation or Peltzman effect: The tendency to engage in riskier behavior when one feels more secure or protected.

Effort justification: The tendency for individuals to assign a higher value to outcomes they have achieved through effort, potentially leading to an overestimation of the outcome's true worth.

Trait ascription bias: The tendency for individuals to perceive themselves as having more fluctuation in their personality, behavior, and moods while considering others to be more consistent and predictable.

Defensive attribution hypothesis: Our tendency to ascribe causality to events arises from discomfort with the notion that occurrences might be random or accidental.

Fundamental attribution error: The tendency to overvalue dispositional or personality-based explanations for the observed behaviors of others, while undervaluing the influence of situational factors on those same behaviors.

Superiority illusion/Illusory superiority/Lake Wobegone effect/Better-than-average-bias: The tendency to overvalue one's own positive attributes and undervalue one's negative traits in comparison to those of others.

Illusion of control: The tendency to overstate one's ability to control or impact external events.

Actor-observer bias: The tendency to attribute the actions of others predominantly to their character traits while downplaying situational factors, and conversely, to attribute one's own actions more to situational circumstances than to personal traits.

Self-serving bias: The tendency to take greater credit for successes than for failures, often accompanied by a propensity to interpret ambiguous information in a self-serving manner.

Forer effect or Barnum effect: The tendency for people to assign high accuracy ratings to personality descriptions that are presented as being uniquely tailored to them, when in reality, these descriptions are sufficiently vague and general to resonate with a broad audience.

Optimism bias/wishful thinking/valence effect/positive outcome bias/compare pessimism bias: The tendency to exhibit excessive optimism by significantly underestimating the likelihood of negative events and overestimating the probability of positive outcomes.

Egocentric bias: The tendency to recall past events in a way that enhances one's self-image, such as remembering one's academic grades as being higher than they actually were or recalling a caught fish as larger than its true size.

Dunning-kruger effect: The tendency of individuals with limited skills to overrate their own capabilities, while those with expertise tend to underrate their own proficiency.

Hard-easy effect: The tendency to overrate one's competence in handling challenging tasks and underrate one's capability to perform easy tasks.

False consensus effect/illusion of agreement/illusion of consensus: The tendency for individuals to overstate the extent to which their opinions, beliefs, or choices are shared by others.

Third-person effect: The tendency to assume that mass media messages have a more significant influence on others than on oneself.

Social desirability bias: The tendency to exaggerate the presence of socially favorable traits or behaviors in oneself while minimizing the reporting of socially unfavorable characteristics or actions.

Identifiable victim effect: The tendency to provide more help to a specific, identifiable person rather than to a broader, anonymous group or to individuals represented merely by statistical data.

Appeal to novelty: This is a fallacy where one incorrectly asserts that an idea or proposal is accurate or superior solely on the basis that it is new and contemporary.

Hyperbolic discounting: It refers to the tendency of individuals to favor immediate rewards over those that are delayed, even if the later payoffs might be larger or more beneficial in the long term.

Present bias: The tendency for individuals to place greater importance on outcomes that are nearer to the present moment when evaluating trade-offs between two points in the future.

Backfire effect: A tendency to respond to evidence that contradicts one's existing beliefs by further entrenching those original beliefs.

Endowment effect: The tendency for individuals to require a higher price to relinquish an object than the amount they would be willing to pay to obtain it.

Processing/Sequential difficulty effect: The tendency for people to better remember information that is more time-consuming or difficult to read and understand.

Pseudocertainty effect: The tendency for individuals to prefer avoiding risks when they anticipate a positive outcome, yet to seek risks when they are trying to avert a negative result.

Disposition effect: The tendency to prefer selling an asset that has increased in value while being reluctant to sell an asset that has decreased in value.

Zero-risk bias: The tendency to focus on completely avoiding current risks, even when alternative options could mitigate a greater amount of risk and yield superior outcomes.

Unit bias: The tendency to view a recommended level of consumption, such as a serving size of food, as the suitable amount to consume, leading a person to eat the entire serving even if it exceeds their individual needs.

Left-digit bias: A phenomenon where the leftmost digit in a product's price disproportionately affects consumers' perceptions and judgments of the product's value.

Spatial bias: The tendency for individuals to focus on the central area of visual stimuli when freely observing images.

IKEA effect: The tendency for consumers to assign an excessively high value to products that they have had a hand in creating or customizing.

Loss aversion: Loss aversion refers to the cognitive bias where the emotional impact of a loss is perceived to be twice as significant as the pleasure derived from an equivalent gain. The distress experienced from losing money or any other valuable item is often more intense than the satisfaction of acquiring the same.

Generation effect: The phenomenon where information one has personally generated is more easily remembered. For example, individuals tend to have better recall for statements they have created themselves compared to those made by others.

Escalation of commitment or Commitment bias: A behavioral pattern where an individual or group persists in a particular action or decision despite experiencing increasingly adverse results, rather than choosing to change direction or cease the behavior.

Sunk cost fallacy: A situation where individuals rationalize further commitment to a decision based on the amount already invested, despite new information indicating that the initial decision may have been incorrect.

Status quo bias: The tendency to favor the maintenance of the status quo or for things to remain relatively unchanged.

Default bias: The tendency to choose the default option when faced with a selection among several possibilities.

Social comparison bias: The tendency to prefer candidates or options that do not challenge one's own specific strengths when making decisions.

Decoy effect: The occurrence where, given a choice between two options, A and B, the preference shifts towards option B when a third option, C, is introduced, which is inferior to option B in every aspect and only partially inferior to option A.

Reactance: The compulsion to act contrary to what someone else desires, driven by the need to resist what is perceived as an encroachment on one's freedom of choice.

Herd bias or Bandwagon effect: The psychological phenomenon where individuals justify a course of action as being correct on the basis that ‘everyone else’ is engaging in it.

System justification: The tendency to uphold and reinforce the existing state of affairs. Current social, economic, and political systems are often favored, while alternative options are devalued, occasionally to the detriment of both individual and collective well-being.

Less-is-better effect: The tendency to favor a smaller set over a larger one when evaluated separately, but not when assessed together.

Occam's razor fallacy: This principle reflects a preference for the hypothesis that offers the simplest explanation while adequately fitting the data. While the razor can be employed to dismiss alternative hypotheses, appropriate justification may be required to support such exclusions.

Conjunction fallacy: The tendency to believe that particular, specific conditions are more likely than a broader, more general version of those same conditions.

Rhyme as reason effect/Keats Heuristic: The phenomenon where statements that rhyme are perceived as more accurate or truthful.

Belief bias: A bias in which an individual's assessment of the logical validity of an argument is influenced by the plausibility of the argument's conclusion.

Information bias: The tendency to pursue information even when it has no impact on one's actions.

Decision paralysis/Choice overload/The choice paradox: Individuals tend to become overwhelmed when faced with a vast array of choices.

Ambiguity Aversion: The tendency to steer clear of choices where the likelihood of a positive result is uncertain.

Spacing effect: The efficacy of learning is enhanced when it is conducted in sessions that are spread out over time. Through repetition and the distribution of learning episodes, individuals are more likely to retain and recall the information later on.

Suggestibility: The phenomenon where suggestions made by an interrogator are mistakenly believed to be memories.

False memory: The occurrence where one confuses imagined scenarios with actual memories.

Cryptomnesia: The occurrence where a memory is misconstrued as a new thought or product of the imagination, due to the absence of a subjective sense that it is being recalled from memory.

Source confusion: The blending of episodic memories with other details leads to the creation of altered or inaccurate recollections.

Misattribution of memory: The incorrect attribution of the source of a memory by the individual recalling the memory.

Fading effect bias: A bias where the emotional intensity of negative memories diminishes more rapidly than the emotional charge associated with positive experiences.

Stereotypical bias: The phenomenon where memory is distorted by baseless beliefs about specific groups, often related to race, gender, and other social categories.

Unconscious bias or implicit bias: It refers to the deep-seated attitudes and stereotypes that individuals unconsciously ascribe to another person or group, influencing their perception and interactions. Researchers propose that such biases are automatic responses wherein the brain rapidly assesses others based on previous experiences and one's background.

Implicit associations: A phenomenon where the rapidity of word-pairing is influenced by the degree of association between the words.

Suffix effect: The selective difficulty in remembering the last few items of a spoken list when an unrelated spoken element, known as a suffix, immediately follows the list.

Serial position effect: The tendency for items at the end of a sequence to be most readily recalled, followed by items at the beginning, with items in the middle being least likely to be remembered.

Part-list cueing effect: The phenomenon where being presented with certain items from a list and subsequently recalling one of them makes it more difficult to recall the remaining items.

Recency effect: The misperception that a phenomenon one has only recently become aware of is itself a new occurrence. This is frequently applied to linguistic phenomena, where there is an illusion that a word or language usage one has only recently observed is a recent development, when in reality, it has been established for a considerable time.

Primacy effect: The phenomenon in which an item at the start of a list is more readily remembered, representing a type of serial position effect.

Modality effect: A learner's performance is influenced by the manner in which the material to be learned is presented.

Duration neglect: The oversight of the length of time an event lasts when assessing its overall value.

List-length effect: The ability to recognize items from a short list is better than the recognition of items from a longer list.

Serial recall effect: The tendency to recall information that appears at the beginning or end of a sequence more easily than information situated in the middle of the sequence.

Misinformation effect: This phenomenon takes place when an individual's recollection of episodic memories is compromised by information encountered after the original event.

Leveling and sharpening: Memory distortions that arise when we are unable to recall specific details of a particular memory.

Peak-end rule: The tendency for individuals to judge an experience largely based on how they felt at its most intense point (its peak) and at its conclusion, rather than the total sum or average of every moment of the experience.

Tip of the tongue phenomenon: The situation in which an individual can remember certain aspects of an item or related details but is vexingly unable to recall the complete item. This is believed to be a case of “blocking,” where the retrieval of multiple similar memories occurs simultaneously and creates interference.

Headwinds/tailwinds asymmetry: Individuals tend to recall the challenges and adversities they faced in past experiences more vividly than the factors that facilitated their success. This reflects a biased perception that their lives have encountered more hindrances than enabling elements for success.

Google effect: The tendency to overlook information that can be easily located online through the use of Internet search engines.

Next-in-line effect: In situations where individuals take turns speaking in a group following a set sequence (such as moving clockwise around a room or using numbered turns), there is a tendency for people to have reduced memory for what was said by the person who spoke directly prior to their turn.

Testing effect: The phenomenon where rewriting information that one has read facilitates better recall than simply rereading the material. Regular testing of memorized content also enhances the ability to recall that information.

Absent-mindedness: This cognitive bias occurs when individuals experience lapses in attention or “zone out,” leading to errors in routine activities or everyday tasks.

Levels of processing effect: The principle that the effectiveness of memory encoding varies depending on the method used to process the information into memory.

Procrastination bias: In decision-making processes, the brain tends to prioritize immediate gratification over potential future benefits. This conflict is often described by scientists as a struggle between one's Present Self and Future Self.

Tunnel effect: The inclination for individuals to feel content with the achievements of others when they perceive that such successes indicate an enhancement of their own opportunities.

Anchoring bias: This phenomenon is a manifestation of the anchoring effect, where individuals tend to evaluate options relative to one another within the same category and struggle to make comparisons across distinct categories.

Framing effect: This refers to the influence of how choices are framed-whether in positive or negative terms, such as potential gains or losses-on decision-making processes.

Action bias: The tendency for an individual to take action in response to a problem even when refraining from action would be more beneficial, or to take action when there is no clear problem present.

Attribute substitution: This occurs when an individual is faced with making a complex judgment about a particular attribute and instead substitutes a judgment based on a simpler, more easily computed heuristic attribute.

End-of-history illusion: The belief, consistent across various ages, that one will experience fewer personal changes in the future compared to the changes one has undergone in the past.

Exaggerated expectation: The tendency to anticipate or forecast outcomes that are more extreme than the events that actually occur.

Form function attribution bias: In the context of human-robot interaction, this tendency refers to the systematic mistakes people make based on their interactions with a robot. These errors often stem from individuals basing their expectations and perceptions of the robot on its physical appearance, leading them to ascribe capabilities to the robot that may not align with its actual functions.

Interoceptive bias or Hungry judge effect: The tendency for one's own bodily sensations or physical state to influence their judgment about external, unrelated events or situations.

Money illusion: The tendency to focus on the face value of money rather than its actual purchasing power or value in terms of what it can buy.

Moral credential effect or Moral licensing effect: This occurs when an individual who engages in a positive or virtuous action subsequently feels entitled to act less virtuously or engage in negative behaviors in the future.

Hot-stove effect/Once bitten, twice shy: This is the tendency to shun a previously made decision after it has led to a negative outcome, even when faced with the same decision problem again and the initial choice was the best one.

Ostrich effect: The tendency to disregard or deny the presence of a clear and negative circumstance.

Plant blindness: The tendency to overlook the presence of plants in one's surroundings and a lack of acknowledgment for the critical role and value that plants contribute to life on Earth.

Probability matching: The less-than-ideal alignment of the likelihood of making certain choices with the probability of receiving rewards in a context characterized by randomness and uncertainty.

Proportionality bias: The inherent tendency to believe that significant events must have substantial causes could also account for our propensity to subscribe to conspiracy theories.

Systematic bias: Judgment that is influenced by the occurrence of unequal regression effects when evaluating targets that are subject to differential assessment.

Surrogation: The phenomenon where one loses awareness of the strategic concept that a metric is meant to signify, and begins to behave as if the metric itself is the construct of interest.

Weber-Fechner law: The challenge encountered when attempting to discern minor differences within large quantities.

Women are wonderful effect: The tendency to attribute a greater number of favorable qualities to women compared to men.

Conservatism bias: The tendency to insufficiently update one's belief in light of new evidence.

Functional fixedness: A tendency that restricts a person to utilizing an object solely in its conventional manner.

Law of the instrument: A tendency to overly depend on a well-known tool or methods, leading to a disregard for or undervaluation of different strategies. This is often encapsulated in the saying, “If all you have is a hammer, everything looks like a nail.”

Ratio bias: The tendency for individuals to perceive a low-probability event as more likely when it is presented as a ratio with larger numbers, like 20/100, compared to when the same probability is presented as a smaller-numbered but equivalent ratio, such as 2/10.

Clustering illusion: The tendency to attribute excessive significance to short sequences, patterns, or clusters found within large sets of random data, essentially perceiving illusory patterns.

Illusory correlation: A tendency to mistakenly identify a connection between two events that are, in fact, unrelated.

Pareidolia: A tendency to interpret ambiguous and random stimuli as meaningful, such as seeing shapes of animals or faces in clouds, discerning the man in the Moon, or perceiving nonexistent subliminal messages in music played backwards.

Anthropomorphism: The tendency to ascribe human characteristics, emotions, and intentions to animals, inanimate objects, and abstract concepts.

Salience bias: The tendency to pay attention to elements that stand out or are emotionally charged, while overlooking those that are ordinary or unremarkable, despite the fact that this distinction may be irrelevant according to objective criteria.

Selection bias: This occurs when the selection of participants for a statistical sample is not entirely random, resulting in a sample that does not accurately reflect the broader population.

Survivorship bias/Survival vias: This refers to the focus on individuals or entities that have endured a particular process, while unintentionally neglecting those that did not make it through, often due to their absence or lack of visibility.

Normalcy bias: The reluctance to prepare for or respond to a catastrophe that has not previously occurred.

Self-image bias/Ben Franklin Effect: Individuals often find it challenging to maintain logical coherence between their behaviors and perceptions.

Congruence bias/Congruence effect: The tendency to exclusively verify hypotheses by direct examination, rather than considering and testing other potential alternative explanations.

Selective perception: The tendency for one's anticipations to influence their sensory experiences or perceptions.

Bias blind spot: The tendency to perceive oneself as being less susceptible to biases than others, or to recognize a greater number of cognitive biases in others than in oneself.

False uniqueness bias: The tendency for individuals to view their own endeavors and themselves as more unique than they truly are.

Illusion of validity: The tendency to overvalue the precision of one's own assessments, particularly when the information at hand is consistent or shows intercorrelation.

Naïve cynicism: The expectation that other half

Naïve realism: The conviction that one's perception of reality is objective and unbiased, assuming that the facts are evident and that rational individuals will concur with one's viewpoint, while those who disagree must be uninformed, indolent, irrational, or prejudiced.

Overconfidence effect: A tendency to exhibit unwarranted certainty in one's own responses to questions. For instance, in certain scenarios, responses that individuals deem to be “99% certain” can be incorrect as much as 40% of the time.

Compassion fade: The tendency to demonstrate greater compassion and take more significant action in response to the plight of a small, identifiable group of individuals as opposed to a large, anonymous group of victims.

Anecdotal bias or fallacy: The anecdotal fallacy is a logical error that arises when anecdotal evidence is used as the primary basis for an argument. This fallacy is prevalent across a broad spectrum of discussions and debates.

Probability neglect: The tendency to ignore the role of probability when faced with decisions that involve uncertainty.

Automation bias: The tendency to rely too heavily on automated systems, potentially resulting in incorrect information from these systems superseding accurate human judgments.

Gender bias: A pervasive collection of implicit biases that manifest as discrimination against a particular gender. Examples include the presumption that women are less capable in roles demanding high intellectual capacity, or the default assumption that individuals or animals are male when there are no explicit indicators of gender.

Sexual over perception bias: The tendency to overestimate someone's sexual interest in oneself, as well as the tendency to underestimate one's own sexual interest in others.

Distinction bias: The tendency to perceive greater differences between two options when they are assessed side by side than when they are considered independently.

Gambler's fallacy: The tendency to believe that the likelihood of future events is influenced by past occurrences, despite the fact that the actual probabilities remain unchanged. This fallacy stems from a misunderstanding of the law of large numbers.

Hot-hand fallacy: The “hot hand fallacy,” also known as the “hot hand phenomenon,” is the belief that a person who has recently experienced success in a random event is more likely to continue achieving success in subsequent attempts.

Subadditivity effect: The tendency to erroneously assess the likelihood of an entire scenario as being lower than the sum of the probabilities of its individual components.

Zero-sum bias: The misperception of a scenario as a zero-sum game, where it is incorrectly assumed that one individual's gain is directly at the expense of another's loss.

Confirmation bias: The tendency to seek out, interpret, or remember information in a manner that validates one's preexisting beliefs or hypotheses.

Pygmalion effect: The phenomenon in which the expectations held by others regarding a particular individual influence that individual's performance.

Groupthink: The psychological phenomenon known as groupthink occurs within a collective where the preference for harmony or conformity leads to irrational or dysfunctional decision-making outcomes.

Halo effect: The tendency for an individual's positive or negative characteristics to influence and color others' perceptions of their different personality attributes.

Authority bias/Obedience bias: The tendency to ascribe higher credibility to the views of an authority figure, regardless of the actual content, and to be more swayed by that opinion.

Cheerleader effect: The tendency for individuals to be perceived as more attractive when they are part of a group than when they are alone.

Courtesy bias: The tendency to express a viewpoint that is more socially acceptable or agreeable, rather than one's genuine opinion, in order to prevent causing offense.

Not invented here: A reluctance to engage with or utilize products, research, standards, or knowledge that originate from outside one's own group.

Scarcity bias: We subconsciously equate scarcity with value, while perceiving things that are plentiful as less valuable.

Need for competence/Competence bias: We have a natural inclination to want to influence and manage our environment.

Regret Aversion: The act of choosing an option based on the desire to avoid the feeling of regret that might come from selecting a different path in the future.

Pain of paying: The greater the discomfort or “pain” associated with making a purchase, the less inclined people are to proceed with the transaction.

Take-the-best Heuristic: A cognitive shortcut employed during decision-making that allows for swift choices between options without requiring comprehensive knowledge about each alternative.

Affect heuristic: We frequently depend on our emotional responses as a basis for decision-making, rather than relying on factual or objective data.

Bounded Rationality: We tend to pursue a decision that is satisfactory or sufficient, rather than striving for the optimal or best possible decision.

Category size bias: Our tendency to perceive outcomes as more probable if they belong to a larger category, as opposed to a smaller one, despite each individual outcome having an equal likelihood of occurring.

Decision fatigue/Ego depletion: Our decision-making capabilities tend to deteriorate after making numerous choices, as our cognitive resources become depleted.

In-group bias: The tendency to show favoritism towards individuals who are members of the same group to which one belongs.

Lag effect: We have a better memory for information when there are extended intervals between the repeated exposures to that information.

Mental accounting: Despite the objective and consistent value of money, the manner in which we choose to spend it is frequently governed by varying principles, influenced by factors such as the method by which we acquired the money, our intended use for it, and the emotional impact associated with spending it.

Naive allocation: Our tendency to distribute resources evenly across available options, irrespective of whether the options themselves are of equal value or importance.

Reactive devaluation: Our tendency to devalue or reject suggestions put forth by another party, particularly when that party is perceived as unfavorable or hostile.

Response bias: Our tendency to give imprecise or untruthful responses to questions that require self-reporting, such as those posed in surveys or structured interviews.

Just world hypothesis: Our belief in the justness of the world, leading to the conviction that the ethical nature of our actions will dictate the outcomes we experience.

The Over justification effect: Our tendency to experience a decrease in intrinsic motivation to engage in an activity we previously enjoyed when we are provided with an external incentive, such as money or a reward.

Bystander effect: We tend to assume that another person will take action in an emergency situation.

Placebo effect: Our minds can deceive us into believing that a placebo or sham treatment has genuine therapeutic effects.

Zeigarnik effect: The tendency to remember interrupted or unfinished tasks more easily than tasks that have been completed.

Outgroup homogeneity bias: The tendency to perceive individuals from outside groups as being more homogenous and alike, especially when compared to the perceived variability within one's own group.

Round number bias: The tendency to prefer numbers that are whole or round over those that are not.

Stockholm bias: When faced with a particularly disadvantageous power dynamic, our emotional responses work in tandem with our cognitive processes to temper feelings of indignation and anger. This is a self-protective reaction to experiencing powerlessness and lacking a means to be heard.

Choice-supportive bias or post-purchase rationalization: The tendency to attribute positive qualities to an option one has chosen after the fact, and/or to downgrade the options that were not selected.

Representativeness Heuristic: This cognitive shortcut involves using similarity to an existing mental prototype as a basis for estimating the likelihood of an event when assessing probabilities.

Affective Forecasting: Affective forecasting, also known as hedonic forecasting, involves making predictions about our future emotional responses to events. As with many aspects of human judgment and decision-making, these predictions can often be flawed or inaccurate.

Chameleon Effect: This phenomenon involves the subconscious imitation of the mannerisms, gestures, or facial expressions of those we frequently interact with. It leads to unintentional behavioral adjustments to align with the behaviors of individuals in our immediate social circles or even those of strangers.

Illusion of Asymmetric Insight: There is a common belief that we have a better grasp of understanding others than they do of understanding us.

Prejudice: An emotional response directed at an individual based on the group to which they are perceived to belong.

All-or-nothing thinking: All-or-nothing thinking is a cognitive distortion that leads to a binary view of the world, perceiving things in absolute terms, such as black or white, with no middle ground. This type of thinking can influence emotions and perceptions of reality, often lacking a basis in factual evidence.

Jumping to conclusions (Hasty generalization, fallacy of insufficient statistics, fallacy of insufficient sample, fallacy of the lonely fact, hasty induction, secundum quid, converse accident): Jumping to conclusions, formally known as the jumping conclusion bias (JTC) and sometimes referred to as inference-observation confusion, is a psychological term that describes a communication barrier in which one makes judgments or decisions without possessing all the necessary information, leading to a conclusion that is not logically justified by sufficient or unbiased evidence.

Mind reading: Mind Reading is a cognitive distortion where an individual assumes they know what others are thinking, such as believing others are judging them negatively, and this assumption becomes so entrenched that they do not seek to verify its accuracy.

Fortune-telling: Fortune telling is a cognitive distortion where an individual anticipates a negative event will occur without taking into account the realistic likelihood of that outcome happening.

Labeling and mislabeling: Labeling involves defining a person solely based on a single action or event. For instance, branding a co-worker as “lazy” for arriving late to work once, or considering oneself “stupid” for not passing a math test. This cognitive distortion, which can also take the form of mislabeling, has the potential to harm an individual's self-esteem and their perception of others.

Emotional reasoning: Emotional reasoning is a cognitive distortion that involves making incorrect assessments about oneself, one's situation, and others based solely on one's current emotional state, rather than on objective reality.

Should/shouldn't and must/mustn't statements: Thoughts that often involve thoughts containing “should,” “ought,” or “must.” Examples include telling oneself, “I should have arrived at the meeting earlier,” or “I must lose weight to be more attractive.” Such thoughts can lead to feelings of guilt or shame.

Gratitude traps: The gratitude trap is a cognitive distortion that emerges from misconceptions about the essence or implementation of gratitude, often leading to counterproductive thinking or behavior.

Blaming others: Blaming is a cognitive distortion where you hold others accountable for your emotional state.

Personalization: Personalization is a cognitive distortion where an individual inappropriately assigns blame to themselves for situations beyond their control, taking on a disproportionate level of responsibility for the outcomes.

Always being right: This cognitive distortion leads an individual to conflate their personal opinions with objective facts, neglecting to acknowledge the perspectives and emotions of others during a debate or discussion.

Fallacy of change: This cognitive distortion is characterized by the expectation that others should alter their behavior or attitudes to align with one's personal preferences or convenience.

Magnification: Magnification is a cognitive distortion that involves overstating the significance of flaws and difficulties, while simultaneously downplaying the value of positive attributes and achievements.

Minimization: Minimizing is a cognitive distortion marked by the inclination to downplay the importance or impact of events, often diminishing their perceived severity or relevance.

Overgeneralization: Overgeneralization is a cognitive distortion in which an individual extends a conclusion drawn from one specific event to all other events, regardless of their similarity or relevance to the original circumstance.

Disqualifying the positive: Disqualifying the positive is a cognitive distortion where an individual dismisses positive experiences, claiming they are irrelevant or unimportant, thus preserving a negative belief despite evidence to the contrary from daily life.

Mental filtering/Selective Abstraction: Selective abstraction, also commonly known as a ‘mental filter,’ is a cognitive distortion that involves focusing on a single detail, frequently out of context, while disregarding other more significant aspects of the experience. This tendency can lead to a skewed or biased perception of events.

Catastrophizing: Catastrophizing is a cognitive distortion that exacerbates anxiety and depression through the overemphasis of potential negative outcomes and the underestimation of one's ability to cope with them.

Comparison: This cognitive distortion involves making unjust comparisons between our own accomplishments and attributes and those of others, neglecting to acknowledge the unique factors that contribute to each person's individual strengths and weaknesses.

Externalization of Self-Worth: Externalization of self-worth is a cognitive distortion where a person's self-esteem is heavily dependent on the opinions and approval of others, rather than on their own intrinsic values and achievements.

Perfectionism: Perfectionism is often considered a result of dysfunctional thought processes. Cognitive behavioral psychologists have identified various cognitive distortions, which are patterns of faulty and inaccurate thinking that contribute to such maladaptive behaviors. Prestige bias: This occurs when individuals provide a response that reflects their personal position or status within a group, rather than objectively conveying the views of the group as a whole.

Time-Shrinking Illusion: The perceived length of brief periods of empty time, specifically those less than approximately 250 milliseconds, can be significantly underestimated if they follow directly after shorter intervals of time.

Survival Processing Effect: This phenomenon refers to the improved memory retention of items when they are processed in relation to a fitness-oriented survival scenario, as opposed to other processing contexts.

Naturalistic Fallacy: The Naturalistic Fallacy is an informal logical fallacy that contends that if something is ‘natural,’ it must inherently be good. This fallacy is closely associated with the is/ought fallacy, which involves drawing conclusions about what ‘ought’ to be done based on observations of what ‘is.’

Appeal to probability: This refers to the assumption that a particular situation or outcome is true or likely to occur without sufficient evidence, simply because it seems probable or possible.

Argument from fallacy: The Argument from Fallacy (also known as the fallacy fallacy) is the erroneous assumption that if an argument for a conclusion is identified as fallacious, then the conclusion itself must be false.

Non sequitur fallacy: The non sequitur fallacy occurs when a conclusion does not logically follow from the premises. It is a type of logical fallacy where the argument's conclusion is not supported by its preceding statements or evidence.

Masked-man fallacy: The masked-man fallacy, also known as the intensional fallacy, involves a confusion between identity and descriptions. It occurs when someone makes an illogical inference based on the fact that they don't recognize a person in disguise, mistakenly concluding that the disguised person and the known person are two different individuals.

Affirming a disjunct: Affirming a disjunct is a logical fallacy that occurs when someone erroneously concludes that one disjunct of a true disjunction must be false because the other disjunct is true.

Affirming the consequent: Affirming the consequent is a formal logical fallacy that occurs in a conditional statement. It takes the form: If P, then Q. Q is true. Therefore, P must be true.

Denying the antecedent: Denying the antecedent is a formal logical fallacy that occurs in a conditional statement. It takes the form: If P, then Q. P is not true. Therefore, Q is not true.

Existential fallacy: The existential fallacy occurs when a conclusion is drawn from a universal premise without any assurance that the terms in the premise actually refer to existing things.

Affirmative conclusion from a negative premise: The fallacy of drawing an affirmative conclusion from a negative premise occurs when a categorical syllogism has a positive conclusion, but one or both of the premises are negative. This is a violation of the rules of valid syllogistic reasoning, as a negative premise typically indicates the absence of something, and it is illogical to infer the existence or affirmation of something based on the absence of another.

Fallacy of exclusive premises: The fallacy of exclusive premises is a type of formal fallacy that occurs in categorical syllogisms when both premises are negative. According to the rules of classical logic, at least one premise must be affirmative to draw a valid conclusion. A syllogism with two negative premises fails to provide a link between the two terms that could lead to an affirmative conclusion.

Fallacy of four terms: The fallacy of four terms is a logical fallacy that occurs in a categorical syllogism when it contains more than the standard three terms (major term, minor term, and middle term).

Illicit major: The fallacy of illicit major occurs in a categorical syllogism when the major term (the predicate of the conclusion) is undistributed in the major premise but distributed in the conclusion. This means that the syllogism draws a conclusion about all members of the major term's category, even though the premise only refers to some of them, leading to an invalid argument

Illicit minor: The fallacy of illicit minor occurs in a categorical syllogism when the minor term (the subject of the conclusion) is undistributed in the minor premise but distributed in the conclusion. This means that the syllogism makes a general claim about all members of the minor term's category based on a premise that does not justify such a broad claim, resulting in an invalid argument.

Negative conclusion from affirmative premises: The fallacy of drawing a negative conclusion from affirmative premises occurs in a categorical syllogism when both premises are affirmative, but the conclusion is negative. This is a violation of the rules of valid syllogistic reasoning, as affirmative premises cannot logically lead to a negative conclusion. A valid syllogism with affirmative premises should also have an affirmative conclusion.

Fallacy of the undistributed middle: The fallacy of the undistributed middle occurs in a categorical syllogism when the middle term, which appears in both premises but not in the conclusion, is never distributed. This means that the middle term does not refer to all members of its category at any point in the argument, leading to a logical error because there is no common ground established between the two other terms in the syllogism.

Modal fallacy: The modal fallacy, also known as the fallacy of necessity, is a logical fallacy that occurs when a conclusion about what is necessary is incorrectly drawn from premises that only assert what is possible or actual.

Modal scope fallacy: The modal scope fallacy is a logical error that occurs when the scope of a modal operator (like “necessarily,” “possibly,” or “probably”) in a statement is misplaced or misinterpreted.

Argument to moderation: The argument to moderation, also known as the middle ground fallacy or false compromise, is a logical fallacy that assumes that the compromise between two opposing arguments must be the correct solution simply because it is the middle position.

Continuum fallacy: Also known as fallacy of the beard, the line-drawing fallacy, sorites fallacy, fallacy of the heap, bald man fallacy, or decision-point fallacy, is a logical error that involves dismissing a claim because it lacks precision. This fallacy occurs when one demands an exact point at which a vague term becomes applicable.

Definist fallacy: The definist fallacy occurs when someone creates a definition that excludes a particular case or includes a preferred case without proper justification.

Divine fallacy: The divine fallacy, also known as argument from incredulity or the God of the gaps fallacy, is a logical error where one concludes that because something is too difficult to understand, or is seemingly inexplicable, it must be due to a divine cause or supernatural phenomenon.

Double counting: It is a logical error where the same event or occurrence is counted more than once, leading to an incorrect total probability that exceeds one (or 100%).

Equivocation: Occurs when a word with multiple meanings is used ambiguously within an argument without clarifying which meaning is intended, leading to a misleading or flawed conclusion. The term's different meanings are exploited to draw an incorrect inference or to obscure the truth of the statement.

Ecological fallacy: It is a logical error that occurs when one makes inferences about individual behavior based on aggregate data for a group.

Fallacy of composition: The fallacy of composition assumes that what holds for individual members of a group necessarily holds for the group as a whole.

Fallacy of division: The fallacy of division assumes that what is true for the whole must also be true for its individual parts.

False attribution: The false attribution fallacy occurs when a claim is presented as originating from a source that did not make that claim.

False authority: The false authority fallacy occurs when an individual is presented as an expert in a field outside of their expertise.

False dilemma: The false dilemma fallacy occurs when only two choices are presented as the only possibilities, when in fact more options exist.

False equivalence: The false equivalence fallacy occurs when two fundamentally different things are presented as being equivalent, despite significant differences.

Feedback fallacy: The feedback fallacy occurs when it is assumed that giving feedback is always beneficial and leads to improved performance.

Historian's fallacy: The historian's fallacy occurs when one assumes that decision makers of the past viewed events from the same perspective and having the same information as those subsequently analyzing the decision.

Historical fallacy: The historical fallacy involves drawing conclusions based on historical events without considering the specific context and circumstances in which those events occurred.

Homunculus fallacy: The homunculus fallacy occurs when a “little man,” or internal entity, is used to explain a phenomenon, thereby avoiding the original question or problem.

If-by-whiskey: The if-by-whiskey fallacy involves giving a response that is contingent on the listener's interpretation, allowing the speaker to appear to agree with both sides of an argument.

Incomplete comparison: The incomplete comparison fallacy occurs when a comparison is made that is missing the necessary information to understand the comparison being made.

Intentionality fallacy: The intentionality fallacy occurs when one assumes that the meaning or value of a work is determined by the creator's intended meaning rather than by the work itself and how it is received.

Kafkatrapping: Kafkatrapping is a rhetorical tactic where someone's denial of an accusation is presented as evidence of guilt.

Kettle logic: Kettle logic is the use of multiple, often inconsistent arguments to defend a position.

Ludic fallacy: The ludic fallacy is the belief that the outcomes of structured situations, such as games and simulations, can be reliably applied to real-life scenarios.

Lump of labor fallacy: The lump of labor fallacy is the misconception that there is a fixed amount of work to be done within an economy, which ignores the potential for job creation.

McNamara fallacy: The McNamara fallacy occurs when decisions are based solely on quantitative observations while ignoring all other factors.

Mind projection fallacy: The mind projection fallacy is the error of projecting subjective beliefs, opinions, or mental states onto external reality as if they were true properties of the world.

Moralistic fallacy: The moralistic fallacy is the assumption that what is morally desirable must also be the natural or actual state of affairs.

Moving the goalposts: Moving the goalposts is the fallacy of changing the criteria for a claim or argument once the initial criteria have been met.

Nirvana fallacy: The Nirvana fallacy is the error of comparing actual situations with unrealistic, idealized alternatives.

Package deal: The package deal fallacy occurs when multiple different claims or concepts are grouped together and treated as a single unified argument or position.

Proof by assertion: Proof by assertion is a fallacy in which a proposition is repeatedly restated regardless of contradiction; sometimes confused with argument from repetition (argumentum ad infinitum, argumentum ad nauseam).

Prosecutor's fallacy: The prosecutor's fallacy is a fallacy of statistical reasoning, typically used by the prosecution to argue for the guilt of a defendant during a criminal trial. Although it is named after prosecutors, it can be used by anyone arguing for or against a proposition. It is a type of selection bias.

Proving too much: The proving too much fallacy occurs when an argument that aims to demonstrate a particular conclusion inadvertently implies false or absurd consequences.

Psychologist's fallacy: The psychologist's fallacy occurs when an observer assumes that their subjective experience reflects the true nature of an event being observed.

Referential fallacy: The referential fallacy involves assuming that words or phrases always refer to existing things and that the meaning of sentences is dependent solely on what they refer to.

Reification: Reification is the fallacy of treating an abstraction as if it were a real, concrete entity.

Retrospective determinism: Retrospective determinism is the fallacy of viewing past events as being inevitable and predictable after the fact.

Slippery slope: The slippery slope is a fallacy that suggests a relatively small first step leads to a chain of related events culminating in some significant effect, much like an object would slide down a slippery slope.

Special pleading: Special pleading is a fallacy in which a person applies standards, principles, rules, or criteria to others while making themselves or certain circumstances exempt from the same critical criteria, without providing adequate justification.

Begging the question: Begging the question is a logical fallacy where the conclusion of an argument is assumed in the premise, often resulting in a circular argument.

Circular reasoning: Circular reasoning is a logical fallacy in which the reasoner begins with what they are trying to end with; the components of the argument circle around to support each other, rather than leading to a conclusive point.

Fallacy of many questions: The fallacy of many questions, also known as a complex question or loaded question, is a logical fallacy that occurs when someone asks a question that presupposes something that has not been proven or accepted by all the people involved.

Faulty generalization: Faulty generalization is a logical fallacy that involves drawing broad conclusions from insufficient or unrepresentative evidence.

Cherry-picking (suppressed evidence, incomplete evidence, argument by half-truth, fallacy of exclusion, card stacking, slanting): Cherry picking is a fallacy that occurs when someone selects only the evidence that supports their argument while ignoring any evidence to the contrary.

Nut-picking: Nut-picking is a fallacy where extreme, fringe, or the least defensible instances of a particular group or argument are presented as representative of the whole.

False analogy: False analogy is a logical fallacy that occurs when an argument is based on misleading, superficial, or implausible comparisons.

Inductive fallacy: An inductive fallacy is a flawed reasoning pattern where the premises do not provide enough support for the conclusion, often due to generalizing from an inadequate set of examples.

Misleading vividness: Misleading vividness is a fallacy where a very detailed, vivid, or emotionally charged example is used to sway opinion, despite being unrepresentative or an exception.

Overwhelming exception: Overwhelming exception is a fallacy where a rule is said to be generally true, but the number of exceptions is significant enough to undermine the claim.

Thought-terminating cliché: A thought-terminating cliché is a commonly used phrase, sometimes passing as folk wisdom, used to quell cognitive dissonance, justify fallacious logic, or dismiss dissent during a discussion.

Questionable cause: Questionable cause is a fallacy that occurs when a cause is incorrectly identified for an effect because the real cause is either not known or is overlooked.

Fallacy of the single cause: The fallacy of the single cause, also known as causal oversimplification, is a logical fallacy that occurs when it is assumed that there is a single, simple cause of an outcome when in reality it may have been caused by a number of only jointly sufficient causes.

Furtive fallacy: The furtive fallacy occurs when outcomes are asserted to have been caused by the malfeasance of decision-makers, based on a hidden or furtive purpose, rather than being the result of the decision-makers' stated reasons or random chance.

Magical thinking: Magical thinking is the fallacy of believing that one's thoughts by themselves can bring about effects in the world or that thinking something corresponds with doing it.

Regression fallacy: The regression fallacy ascribes cause where none exists. The flaw is failing to account for natural fluctuations. It is frequently a special kind of the post hoc fallacy.

Inverse gambler's fallacy: The inverse gambler's fallacy is the fallacy of concluding, from the fact that a certain outcome has occurred, that the probabilistic process generating the outcome must have occurred many times before.

P-hacking: This describes the fallacy of mistaking the significance of a research finding without considering the context of multiple comparisons or experiments, where only the most significant results are reported, potentially leading to an overestimation of the true effect.

Garden of forking paths fallacy: The garden of forking paths fallacy refers to a situation in statistical analysis where multiple comparisons or multiple hypotheses are considered without proper control, leading to a high chance of a false positive result. This fallacy is named after Jorge Luis Borges' short story, which depicts a labyrinth of diverging paths, symbolizing the numerous directions that a statistical analysis

Appeal to the stone: This is known also as the appeal to ridicule or the fallacy of ridiculing a claim without providing evidence for its absurdity.

Invincible ignorance: Invincible ignorance is the fallacy of insisting on the correctness of a position despite contradictory evidence, often refusing to engage with that evidence.

Argument from ignorance: The argument from ignorance is a fallacy that asserts a proposition is true because it has not yet been proven false, or vice versa.

Argument from incredulity: The argument from incredulity is a fallacy where one concludes that because they find a concept difficult to understand, or are unaware of how it works, it must be untrue or implausible.

Argument from repetition: The argument from repetition is a fallacy that occurs when a statement is repeated until it is taken as the truth, not because of compelling evidence, but simply due to the repetition.

Argument from silence: The argument from silence is a fallacy that occurs when a conclusion is drawn based on the absence of statements or evidence, assuming that silence implies consent or the truth of a proposition.

Ignoratio elenchi: Ignoratio elenchi, also known as an irrelevant conclusion, is a fallacy where an argument fails to address the issue in question and instead presents an argument related to a different issue.

Red herring: A red herring is a fallacy that distracts from the original topic or argument by introducing an irrelevant issue or piece of information.

Ad hominem: Ad hominem is a fallacy that attacks the person making an argument rather than the argument itself.

Poisoning the well: Poisoning the well is a fallacy where adverse information about a target is preemptively presented to an audience, with the intention of discrediting or ridiculing everything that the target person is about to say.

Appeal to motive: An appeal to motive is a fallacy where a premise is dismissed by calling into question the motives of its proposer.

Tone policing: Tone policing is a fallacy that focuses on the emotion behind a message rather than the message itself as a way to dismiss or detract from the validity of the argument being presented.

Traitorous critic fallacy: The traitorous critic fallacy occurs when a critic's allegiance is questioned as a means to discredit their criticism, rather than addressing the substance of the criticism itself.

Appeal to accomplishment: An appeal to accomplishment is a fallacy where one's achievements are used as evidence for the validity of their argument, suggesting that expertise or success in one area translates to credibility in another.

Courtier's reply: The courtier's reply is a fallacy that dismisses criticisms or objections due to the critic's lack of specific knowledge or qualifications, often used to avoid addressing the substance of the criticism.

Appeal to consequences: An appeal to consequences is a fallacy that argues the truth or falsehood of a statement by appealing to the desirability of its consequences.

Appeal to emotion: An appeal to emotion is a fallacy that uses the manipulation of emotions, rather than valid logic, to win an argument.

Pooh-pooh: The pooh-pooh fallacy involves dismissing an argument as unworthy of serious consideration, often with ridicule or contempt, without giving it a fair hearing or refuting its premise.

Appeal to poverty: An appeal to poverty, or argumentum ad lazarum, is a fallacy that suggests a conclusion or proposition must be true or good because the proposer is poor or has a disadvantaged background.

Appeal to tradition: An appeal to tradition is a fallacy that argues something is good or correct simply because it is traditional or has always been done.

Argumentum ad baculum: Argumentum ad baculum is a fallacy that uses the threat of force or intimidation to compel acceptance of a conclusion.

Argumentum ad populum: Argumentum ad populum is a fallacy that concludes a proposition to be true because many or most people believe it.

Association fallacy: An association fallacy is a logical error where qualities of one thing are erroneously attributed to another, based on an association between the two.

Logic chopping (nit-picking, trivial objections): Logic chopping, also known as argumentum ad logicam, is a fallacy that criticizes an argument by focusing on minor details and ignoring the main point, often to the point of absurdity.

Ipse dixit (Assertion fallacy): Ipse dixit is a fallacy that asserts a proposition is true simply because it has been stated by a perceived authority or expert on the matter.

Bulverism: Bulverism is a fallacy where instead of dealing with the actual argument, one assumes it is wrong and then goes on to explain why the other person holds that erroneous belief.

Chronological snobbery: Chronological snobbery is a fallacy that dismisses an idea or argument as outdated and therefore invalid, simply because it originated in the past.

Genetic fallacy: The genetic fallacy is a fallacy of irrelevance that is based solely on someone's or something's history, origin, or source rather than its current meaning or context.

I'm entitled to my opinion: “I'm entitled to my opinion” is a fallacy that suggests a claim is true or beyond challenge simply because it is the speaker's opinion.

Moralistic fallacy: The moralistic fallacy is the inverse of the naturalistic fallacy and describes the deduction of factual conclusions from purely evaluative premises in violation of fact-value distinction. For instance, “murder is wrong” does not imply that it does not occur.

Straw man: A straw man is a form of argument and an informal fallacy based on giving the impression of refuting an opponent's argument, while actually refuting an argument that was not presented by that opponent.

Texas sharpshooter fallacy: The Texas sharpshooter fallacy is an informal fallacy which is committed when differences in data are ignored, but similarities are stressed. From this reasoning, a false conclusion is inferred. This fallacy is the philosophical/rhetorical application of the multiple comparisons problem in statistics, and it is used to explain the “clustering illusion”.

Tu quoque: Tu quoque (“you too”) is an informal fallacy that intends to discredit the opponent's argument by asserting the opponent's failure to act consistently in accordance with its conclusion(s).

Two wrongs make a right: Two wrongs make a right is a fallacy that occurs when it is assumed that if one wrong is committed, another wrong will cancel it out.

Vacuous truth: A vacuous truth is a statement that asserts a truth about all members of an empty set or a condition that applies to no instances, making the statement true in a trivial or uninformative way.

Availability heuristic/bias: Increased propensity to remember and assign significance to instances that are recent, proximate, or readily accessible, as opposed to those that are less immediate.

It will be understood that the embodiments described herein are merely exemplary and that a person skilled in the art may make many variations and modifications without departing from the spirit and scope of the invention. All such variations and modifications are intended to be included within the scope of the invention.

1. A digital detector for cognitive bias, comprising:
a Knowledge Base (KB) containing data on various types of cognitive biases, cognitive distortions, and logical fallacies, including definitions, examples, and patterns.
a Cognitive Error and Logical Fallacy Detector (CELFD), configured to process and analyze input to identify potential cognitive errors and logical fallacies within said input, informed by said Knowledge Base;
a Rational Advisor (RA), configured to diagnose and generate suggestions to mitigate said potential cognitive errors and logical fallacies identified by said CELFD;
a User Dashboard (UD), adapt to present and generate reports based on said potential cognitive errors and logical fallacies and said suggestions.
a User Interface (UI), adapted to allow a user to submit content for evaluation of arguments and reasoning; and
a Data Storage Component (DS), configured to serve as a repository for all data entered into the detector, as well as output generated by the detector.

2. The detector of claim 1, wherein said Knowledge Base comprises information on various aspects of the logical reasoning and rational thinking, including definitions, examples, and patterns.

3. The detector of claim 1, wherein said Knowledge Base further comprises a database of world facts, including statistics and evidence-based findings, which is collected from external sources.

4. The detector of claim 1, wherein information within said knowledge base is sourced and regularly updated.

5. The detector of claim 1, wherein said CELFD is adapted to perform NLP tasks on said input after converting it to text.

6. The detector of claim 5, wherein said NLP tasks comprise at least one of tokenization, named entity recognition, and sentiment analysis.

7. The detector of claim 5, wherein said CELFD is adapted to apply information from said Knowledge Base to said content, evaluate arguments and reasoning presented, and determine if there are any cognitive errors or logical fallacies present in said processed input.

8. The detector of claim 5, wherein said CELFD is adapted to utilize pre-trained and fine-tuned custom AI models to detect and highlight said potential cognitive errors and logical fallacies in said input.

9. The detector of claim 1, wherein said RA is adapted to employ artificial intelligence models and prescriptive analytics to furnish comprehensive insights regarding said potential cognitive errors and logical fallacies identified by said CELFD.

10. The detector of claim 1, wherein said RA is adapted to highlight possible consequences of said potential cognitive errors and logical fallacies.

11. The detector of claim 1, wherein said RA is adapted to offer strategic recommendations for addressing, managing, and mitigating said potential cognitive errors and logical fallacies.

12. The detector of claim 1, wherein said UD further comprises a feedback mechanism.

13. The detector of claim 12, wherein said feedback mechanism is adapted to provide text-based feedback comprising a written summary of findings.

14. The detector of claim 12, wherein said feedback mechanism is adapted to provide visual representations which map out structure of arguments.

15. The detector of claim 12, wherein said feedback mechanism is adapted to provide audio feedback.

16. The detector of claim 1, wherein said User Interface is adapted to accept said submitted content in textual, vocal, and visual formats.

17. The detector of claim 1, wherein said User Interface is text-based.

18. The detector of claim 1, wherein said User Interface comprises a graphical user interface.

19. The detector of claim 18, wherein said graphical user interface incorporates visual elements and interactive components that enhance user experience.

20. The detector of claim 1, wherein said DS is further adapted to store a record of user interactions with said detector.

21. The detector of claim 20, wherein said record comprises information on the users.

22. The detector of claim 21, wherein said information on the users comprises at least one of: individual preferences, historical usage patterns, or custom settings configured by the users.

23. The detector of claim 21, wherein said DS is adapted to utilize both cloud servers and local servers.

24. A method for using a cognitive error and logical fallacy checking system, comprising the steps of:
collecting and labeling a large dataset of texts related to all domains where the system could be used;
training a machine learning model on said dataset to identify and categorize cognitive biases and logical fallacies in text form;
integrating said machine learning model with existing writing platforms;
analyzing user-written texts to identify potential cognitive biases and logical fallacies by users;
providing feedback and suggestions to the users on how to improve the user-written texts and reduce the presence of cognitive biases and logical fallacies;
continuously monitoring the system's performance and improving it based on feedback and user behavior.
